(19) United States
(12) Patent Application Publication
(10) Pub. No.: US 2005/0041020 A1
(43) Pub. Date: Feb. 24, 2005

(54) Wide temperature range PDLC shutter

(75) Inventors: John Roes, San Diego, CA (US); Deepak Varshneya, Del Mar, CA (US); Tony Maryfield, Poway, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cubic Corporation, San Diego, CA (US)

(21) Appl. No.: 10/869,310

(22) Filed: Jun. 15, 2004

Related U.S. Application Data
(60) Provisional application No. 60/479,204, filed on Jun. 17, 2003.

(51) Int. Cl. G09G 5/00

(52) U.S. Cl. 345/211

(57) ABSTRACT

A Polymer Dispersed Liquid Crystal (PDLC) capable of consistent performance over a wide temperature range. The PDLC includes electrodes connected to each of the resistive layers, such as ITO layers, of the PDLC. A FET switch couples each electrode to a corresponding capacitor. The capacitors are charged using a power source. The energy stored in the capacitors can be transferred to the resistive layers to heat the PDLC. A controller can pulse the FET switches to control the amount of energy transferred from the capacitors to the resistive layers.

### CROSS-REFERENCES TO RELATED APPLICATIONS

This application claims priority to U.S. Provisional Application No. 60/479,204 (Attorney Docket No. 014801-005700US) filed Jun. 17, 2003 which is herein incorporated by reference for all purposes.

### BACKGROUND OF THE INVENTION

Polymer Dispersed Liquid Crystal (PDLC) structures can be used to selectively transmit or occlude incident light. A PDLC structure can be used as a privacy window that can selectively be made opaque by controlling the field applied to a transparent polymer having liquid crystals dispersed within it. PDLC devices may also be used in optical instruments operating in visible and near infra red spectrum.

PDLC structures generally consist of two layers of transparent glass or plastic. Each of the transparent layers is coated on one side with a transparent conducting deposit, such as Indium-Tin-Oxide (ITO). The two transparent layers sandwich a layer of PDLC material. When an AC electrical voltage, typically at 5000 Hertz, is applied between the two ITO coatings, the PDLC is exposed to an electrical field that aligns the dispersed droplets of the anisotropic liquid crystal embedded in the polymer layer. The index of refraction of the aligned liquid crystal droplets then equals the index of refraction of the polymer and the PDLC becomes transparent. When the aligning AC voltage is removed, the alignment in the liquid crystal droplets is lost.

The rate at which the PDLC becomes transparent when the AC voltage is applied and the rate at which the PDLC becomes opaque when the voltage is removed is related to a sensitivity of the liquid crystal to the applied field, the viscosity of the liquid crystal, the size of the liquid crystal droplets, and the degree of thermal agitation. Because viscosity and thermal agitation are strongly affected by the temperature of the liquid crystal, the operational speed of the PDLC can decrease by an order of magnitude between +20° C. and −20° C. Therefore, it may be desirable to maintain the temperature of the PDLC within a relatively narrow range in order to maintain consistent operational speed. However, maintaining the PDLC at a constant temperature tends to require substantial electrical power which is typically at a premium in portable devices.

### BRIEF SUMMARY OF THE INVENTION

A PDLC system and method capable of consistent performance over a wide temperature range is disclosed. The PDLC includes electrodes connected to each of the resistive layers, such as ITO layers, of the PDLC. A FET switch couples each electrode to an isolated DC-DC converter and an energy storage capacitor. The capacitor is charged using a battery operated power source. The energy stored in the capacitors can be transferred to the resistive layers to heat the PDLC. A controller can pulse the FET switches to control the amount of energy transferred from the capacitors to the resistive layers.

The PDLC system and method can be configured to rapidly heat and control the thin PDLC layer for the time needed for device operation. In one embodiment, the operating time period is less than 0.1 second and repeats at irregular intervals. The required energy to operate the system ten times per hour using pulse heating as described herein requires 0.1% of the energy needed to maintain a constant temperature. Accordingly, the required energy can be supplied by a set of AA batteries or some other portable power source.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a functional block diagram of a prior art PDLC shutter.

FIGS. 2A-2B are functional block diagrams of embodiments of a wide temperature range PDLC system.

FIG. 3 is a schematic diagram of an embodiment of a wide temperature range PDLC system.

FIG. 4 is a timing diagram of a sequence of events in an embodiment of a wide temperature range PDLC.

FIG. 5 is a flowchart of an embodiment of a method of operating a wide temperature range PDLC system.

### DETAILED DESCRIPTION OF THE INVENTION

In applications such as portable devices, the size and power consumption of a PDLC is typically limited. It may be infeasible to continually maintain a PDLC at a predetermined temperature with a heater due to power constraints and size constraints. A battery of sufficient size and capacity to power a constant temperature heater would make the PDLC prohibitive for use in a portable system.

The disclosed PDLC is capable of consistent operation over a wide temperature range and is capable of rising to an operational temperature in a fraction of a second. The relatively small size and low power consumption of the PDLC make it suitable for use in portable systems.

The wide temperature range PDLC includes transparent conductive layers positioned on opposing sides of a PDLC layer. The side of each transparent conductive layer that is opposite the PDLC layer can be configured to be adjacent to a transparent substrate.

An electrode can be bonded to each transparent conductive layer. The electrodes can be the same as, or independent of, the electrodes used to apply an AC field to the PDLC layer. Switches couple each of the electrodes to a power source, which can be developed from an energy storage capacitor. The power source can be initially energized while the switches are in an open position. A controller can then selectively command the switches to a closed position to transfer energy from the power source to the transparent conductive layers. The duration of the switch closure and the number of switch closures can be controlled using a feedback system that monitors the temperature of the transparent conductive layers, and thus, the temperature of the PDLC layer.

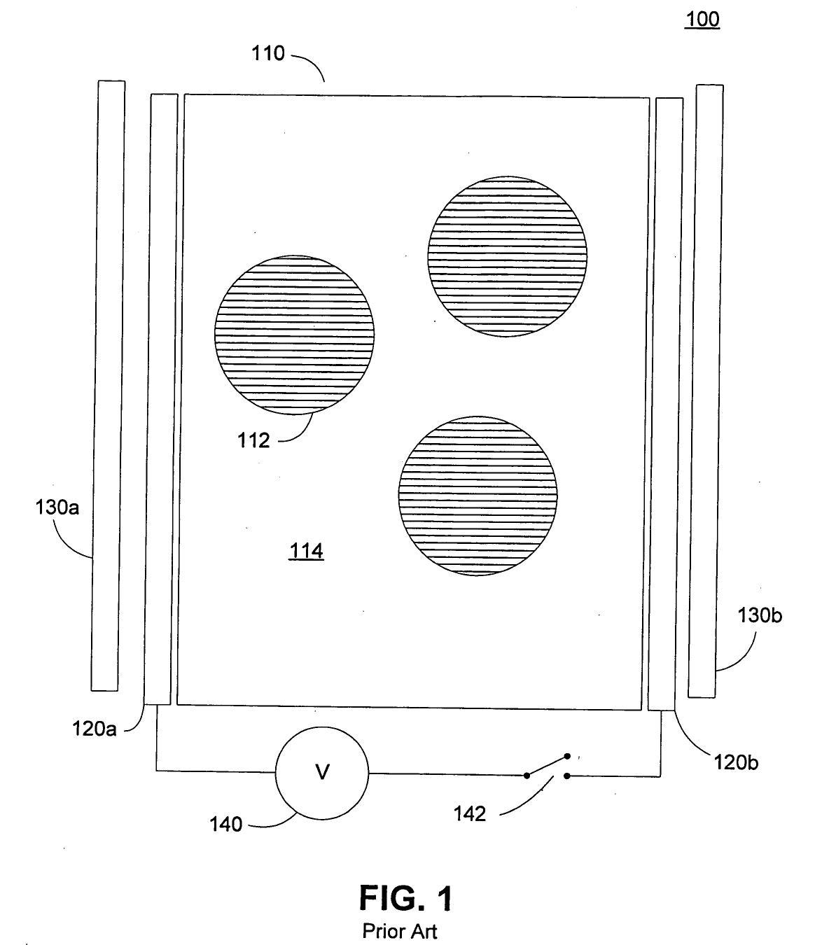

FIG. 1 is a functional block diagram of a prior art PDLC device 100. The PDLC device 100 includes a PDLC layer 110 having liquid crystal droplets 112 dispersed in a transparent polymer 114. Transparent conductive layers are positioned on opposite sides of the PDLC layer 110. The transparent conductive layers can be, for example, Indium-Tin-Oxide (ITO) layers 120a and 120b. The ITO layers 120a and 120b can be supported by transparent substrates 130a and 130b. The transparent substrates 130a and 130b can be, for example, glass, plastic, or some other type of transparent substrate material.

An AC electric field is applied to the PDLC layer 110 in order to align the director in the liquid crystal droplets 112 with the electric field. A voltage source 140 can be coupled to the ITO layers 120a and 120b using a switch 142. To apply an electric field to the PDLC layer 110, the switch 142 is closed to allow the voltage source 140 to apply the voltage across the ITO layers 120a and 120b. In the presence of the electric field, light incident on the device 100 can transmit through the layers and the device 100 appears substantially transparent. In absence of the electric field, the director in the liquid crystal droplets 112 has no preferred orientation, and thus light incident on the device 100 is substantially occluded by the device 100.

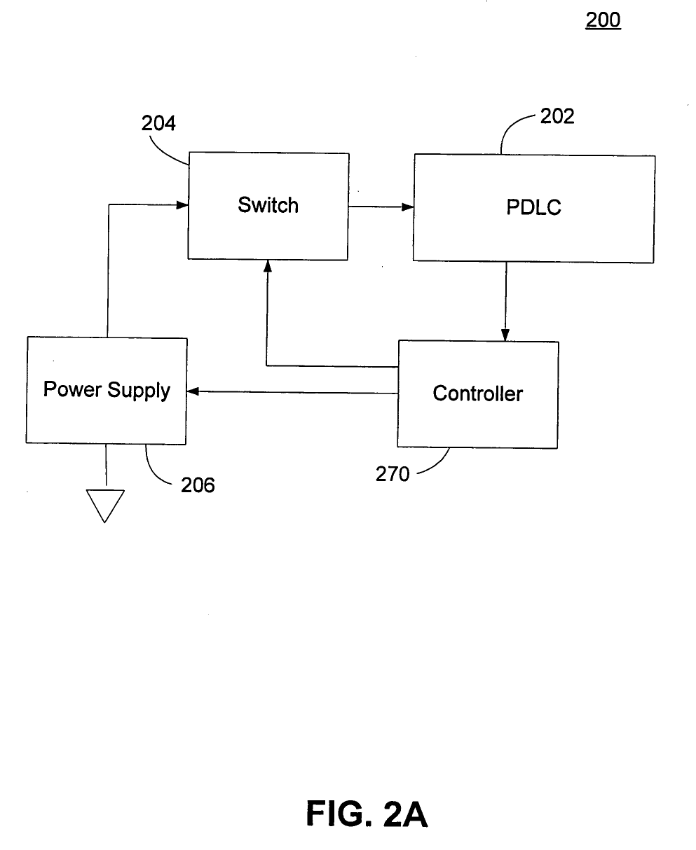

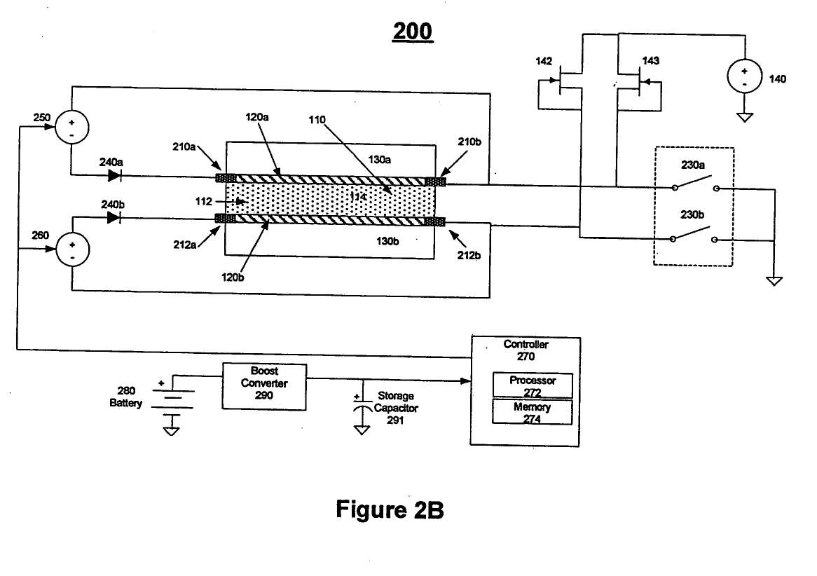

FIG. 2A is a functional block diagram of a wide temperature range PDLC system 200. The PDLC system 260 includes a PDLC 202 having heating elements coupled by a switch module 204 to a heating power source 206. A controller 270 can control the operation of the heating system by, for example, controlling the heating power source 206 and the positions of one or more switches in the switch module 204. The controller 270 can also be configured to monitor the temperature of the PDLC 202. The controller 270 can monitor the temperature of the PDLC 202 directly, for example, using a temperature sensor or can monitor the temperature of the PDLC 202 indirectly, such as by determining the temperature of an element o the PDLC or determining one or more characteristics that correlate with temperature.

FIG. 2B is a functional block diagram of an embodiment of a wide temperature range PDLC system 200. The PDLC system 200 includes a PDLC configured to provide polymer heating in conjunction with power supplied by an external source. The PDLC is coupled to a voltage source using a full bridge driver that includes switch 230a and 230b and depletion mode FETs 142a and 142b that is configured to selectively apply a voltage to the ITO layers 120a and 120b of the PDLC device to control the PDLC device to a transparent state.

Additionally, the ITO layers 120a and 120b include electrodes, 210a, 210b, 212a and 212b that interface with the heating power sources 250 and 260. For example, a first ITO layer 120a can include first and second electrodes 210a and 210b, respectively, positioned on opposite sides of the PDLC device. The first electrode 210a is coupled to a first heating power source 250 through a first series diode 240a. The second electrode 210b is coupled to the first heating power source 250 return. The heating power source 250 can be an isolated type with low stray capacitance to avoid interfering with the operation of the PDLC during AC excitation.

Similarly, the second ITO layer 120b can include first and second electrodes 212a and 212b, respectively, positioned on opposite sides of the PDLC device. The first electrode 212a is coupled to a second heating power source 260 through a second series diode 240b. The second electrode 212b is coupled to the second heating power source 260 return. As for the first ITO layer 120a, the second heating power source 260 can be an isolated type with low stray capacitance to avoid interfering with the operation of the PDLC during AC excitation.

The heating power sources 250 and 260 can be developed from an energy storage capacitor 291 and a suitable DC-DC converter. The controller 270 commands the DC-DC converter to regulated the DC voltage applied to the PDLC layers and controls the length of time and frequency of heat application. A feedback system that measures the PDLC temperature can regulate the amount of heat applied over a wide ambient temperature range. A voltage source such as a battery 280 or low voltage DC source can be coupled to a switch mode power supply, such as for example, a boost converter 290, that selectively steps up the battery voltage and charges an energy storage capacitor 291. The stored energy can be utilized by the DC-DC converter heating system upon command of the controller 270. The energy storage capacitor 291 can be maintained to peak voltage by the battery 280 and the boost DC-DC converter 290 until heat is applied to the PDLC.

A controller 270 can be configured to control the operation of the heating power sources 250 and 260 and the closure of the switches 230a and 230b. For example, the controller 270 can include a processor 272 and memory 274 configured to control the heating power sources 250 and 260 and switches 230a and 230b based in part on a temperature of the PDLC device and a desired time that the PDLC will be in the transparent state.

The PDLC device can be generally constructed as a conventional PDLC device, with the exception of the electrodes on the ITO layers 120a and 120b. In one embodiment, the transparent substrates 130a and 130b are selected to be thermally insulating materials. Additionally, it is advantageous for the materials to have a low coefficient of thermal expansion. The transparent substrates 130a and 130b can be, for example, quartz, glass, plastic, and the like, or some other material having the desired properties. The layers can be configured to have a thickness greater than the thickness of the PDLC layer. In one embodiment, the quartz substrate layer is approximately 0.75 mm thick.

The ITO layers 120a and 120b on glass or plastic substrates can be commercially available products such as those available from Delta Technologies Ltd. The electrical resistance of typical ITO layers 120a and 120b is approximately 100 ohms/square. The electrical resistance of the ITO layers 120a and 120b value can be used in the determination of the values of the energy storage capacitor 291 used to supply power to the ITO layers 120a and 120b.

The energy storage capacitor 291 can be any type of capacitor or multiple of capacitors having a rating sufficient to store the energy used to heat the PDLC layer 110. In one embodiment, the energy storage capacitor 291 is a 150 microfarad 300 volt electrolytic capacitor, which can be sufficient to heat three PDLC devices simultaneously at −20° C. ambient.

A battery 280 can be used to supply the heater power. In one embodiment, the battery 2860 is a typical AA battery that provides a nominal 1.5 volt output. Although a battery is shown in the embodiment of FIG. 2B, any type of power source may be used. The power source is not limited to a DC power source, nor is it limited to a low voltage source. For example, the power source could be a low voltage DC power source, a low voltage AC power source, a line voltage AC power source, a high voltage AC power source, and the like, or some other source for providing power to the PDLC system 200.

The heating power sources 250 and 260 can be any type of power supply, such as a DC-DC converter, configured to provide a sufficient output voltage to the PDLC layers for a given input. The input voltage to the heating power sources 250 and 260 is provided by the energy storage capacitor 291. In the embodiment shown in FIG. 2B where the power source is the energy storage capacitor 291, the heating power sources 250 and 260 can be configured as a step down DC-DC converter configured to provide a 15 volt output.

In other embodiments where the energy source is a source other than the energy storage capacitor 291, the heating power sources 250 and 260 may be a step up DC-DC converter. In still other embodiments, the heating power sources 250 and 260 can be an AC-DC converter. In the situation in which the energy source is at the desired voltage heating power sources 250 and 260 may be switches that selectively connect the energy source to the corresponding PDLC layers.

The switches 230a and 230b can be any type of switch. Typically, the switches 230a and 230b are FET switches designed to operate at the excitation voltage of the voltage source 140 when the switch 230a and 230b are in the open position. However, the switches 230a and 230b can be any type of switch capable of operating in the operating environments and with sufficient switching speed.

In one embodiment, the PDLC device is approximately one centimeter square. The PDLC layer 110 can include one or more UV curable monomers, such as Norland Optical Adhesive NOA 65 or a UV curable monomer from Merck Ltd. such as PN-393. Additionally, the PDLC layer 110 can include one or more polymers such as a thermally cured epoxy resin such as EPON 828 from Shell, trimethylolpropane triglycidyl ether from Aldrich, or the mercaptan based curing agent Capcure 3-800 from Henkel. Additionally, the polymer can include a thermoplastic polymer such as polymethylmethacrylate (PMMA).

The monomer or polymer can be mixed with a nematic liquid crystal mixture such as E-7 from BDH or TL-205 formulated for use with the polymer system. The PDLC layer 110 of one embodiment was approximately 16 μm thick. In another embodiment, the PDLC layer 110 was approximately 40 μm thick. Still other embodiments had PDLC layers 110 of 25 μm, 50 μm, and 100 μm thickness.

It may be advantageous to have a liquid crystal droplet 112 size that is on the order of the wavelength of light that is to be passed by the PDLC layer 110. For example, a liquid crystal droplet 112 size of approximately 1.55 μm can be used for a visible light PDLC layer 110. The droplet dimension of 1.55 μm is approximately three times the wavelength of a portion of the visible light spectrum.

Examples of embodiments of PDLC layers 110 are provided in the following table.

TABLE 1

| | NOA65/E7 | PN393/TL205 | PMMA/E7 | Epoxy/E7 |
|---|---|---|---|---|
| Polymer:LC | 50:50 | 24:76 | 40:60 | 60:40 |
| Sample No. | 104B1 | 104C1 | 104A1 | 102A1 |
| V90 | 29 V | 60 V | 32 V | 24 V |
| Turn-On Time | 30 msec | 7 msec | 10 msec | 50 msec |
| (0-90%) | (29 V) | (50 V) | (32 V) | (24 V) |
| | 8 msec | 3 msec | 4 msec | 40 msec |
| | (50 V) | (60 V) | (50 V) | (50 V) |
| | 1 msec | 3 msec | 1 msec | 7 msec |
| | (80 V) | (80 V) | (80 V) | (80 V) |
| Turn-Off Time | 25 msec | 7 msec | 10 msec | 60 msec |
| (100-10%) | (29 V) | (50 V) | (32 V) | (24 V) |
| | 25 msec | 6 msec | 50 msec | 55 msec |
| | (50 V) | (60 V) | (50 V) | (50 V) |
| | 25 msec | 6 msec | 1000 ms | 55 msec |
| | (80 V) | (80 V) | (80 V) | (80 V) |
| %T OFF | 1.6% | 2.1% | 2.9% | 1.1% |
| %T ON | 82% | 81% | 86% | 88% |
| Contrast Ratio | 52:1 | 39:1 | 30:1 | 83:1 |

In the embodiment the transparent substrates 130a and 130b can be 0.75 mm thick quartz substrates bonded to ITO layers 120a and 120b. The resistance of each ITO layer 120a and 120b is approximately 100 ohms per square, and thus 100 ohms for a 1 centimeter square area.

The PDLC system 200 can be configured for a consistent operational speed over the temperature range of −20° C. and +55° C. Other embodiments may be configured for consistent operational speed over different temperature ranges. For example, the temperature ranges can extend from −20° C. to +70° C., −40° C. to +55° C., −40° C. to +70° C., and the like, or some other temperature range.

The PDLC having a PDLC layer 110 manufactured using one or more of the materials described above can have relatively consistent operational speed over the temperature range of +25° C. to +70° C. However, below +25° C., the shutter operation of the PDLC can slow considerably. Thus, it may be advantageous to heat the PDLC to a temperature within the range of +25° C. to +70° C. before operation in order to maintain a consistent operational speed. For other embodiments, the desired temperature range may be some other temperature range over which the PDLC maintains consistent operational characteristics. In order to conserver power, it may be advantageous to not heat a PDLC that is already within the desired temperature range.

In one embodiment, the operating temperature range may be −20° C. to +55° C. and it may be desirable to operate the PDLC at a temperature that is above +20° C. Thus, the PDLC system 200 may be configured to heat the PDLC when the temperature of the PDLC is below +20° C. Furthermore, in applications in which the PDLC is used as a shutter, the heating time may be extremely limited. For example, the PDLC system 200 may be configured to heat a 1 cm square PDLC from a temperature of −20° C. to +20° C. in 0.02 seconds.

The ITO layers 120a and 120b can be heated from approximately −20° C. to +20° C. in a period of 0.02 seconds using a 10 microfarad electrolytic capacitor as the energy storage capacitor 291 and DC-DC converters for each of the heating power sources 250 and 160 coupled to each of the ITO layers 120a and 120b.

The energy storage capacitor 291 can be charged to a voltage of 300 VDC using a battery 280 and the boost converter 290. The energy stored in the energy storage capacitor 291 can be discharged into the ITO layers 120a and 120b by selectively enabling the heating power sources 250 and 260. The controller 270 can selectively activate the heating power sources 250 and 260 to control the energy supplied to the ITO layers 120a and 120b.

The controller 270 can also be configured to provide a high impedance constant current source to one or more of the ITO layers 120a and 120b. The voltage across the ITO layer, for example 120b, can be measured between the heating pulses. The measured voltage can be used as a temperature monitor. Thus, the controller 270 can control the ITO 120a and 120b temperature by modulating an activation signal supplied to the heating power sources 250 and 260 coupling the energy from the energy storage capacitor 291 to the ITO layers 120a and 120b.

Thus the controller 270 can heat a 1 cm square PDLC from −20° C. to +20° C. in a period of 0.02 seconds using 300 volt 10 microfarad capacitors. Typically, only a fraction of the mass of the quartz substrate layers 130a and 130b is heated as a shuttering operation may occur in a period of approximately 0.09 seconds, including 0.02 seconds used to heat the PDLC and 0.07 seconds during which the temperature of the PDLC is maintained. Thus the shuttering operation can complete before a substantial amount of the heat penetrates the relatively thick quartz substrate layers.

In the above described 1 cm square PDLC embodiment, the energy used to effect a 40° C. temperature rise is approximately 2 calories or 0.5 Joules. This level of energy can be provided by two 300 VDC electrolytic 150 microfarad capacitors. In this embodiment, a single AA battery can provide approximately 10,000 heating operations.

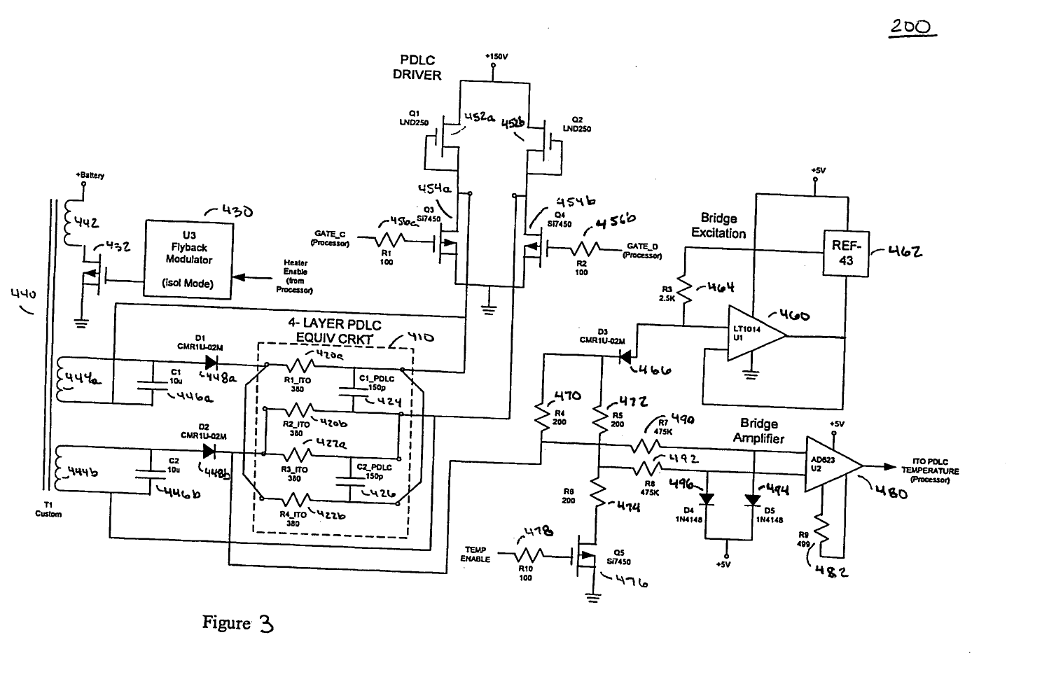

FIG. 3 is a schematic diagram of an embodiment of a wide temperature range PDLC system 200. The PDLC system 200 can be the system shown in the functional block diagram of FIG. 2A.

In the embodiment of FIG. 3, the PDLC 410 is configured as a multi-layer PDLC. The PDLC 410 includes at least two PDLC layers and corresponding pairs of ITO layers. The PDLC 410 is shown in the schematic as an equivalent circuit. The equivalent circuit of the PDLC 410 includes a first PDLC with a first ITO layer 420a and a second ITO layer 420b positioned on the side of the PDLC layer opposite the first ITO layer 420a. The ITO layers 420a and 420b in combination with the PDLC layer effectively form a parallel plate capacitor, shown as capacitor 424.

A second layer of the multi-layer PDLC 410 can also be characterized using a equivalent circuit. The second PDLC includes a first ITO layer 422a and a second ITO layer 422b positioned on the side of a PDLC layer opposite the first ITO layer 422a. The ITO layers 422a and 422b can be resistive ITO layers. The ITO layers 422a and 422b in combination with the PDLC layer effectively form a parallel plate capacitor, shown as capacitor 426.

ITO layers of the first and second PDLC may be coupled together. For example, the first ITO layer 420a in the first PDLC can be coupled to the second ITO layer 422b in the second PDLC. Similarly, the second ITO layer 420b in the first PDLC can be coupled to the first ITO layer 422a in the second PDLC.

A full bridge PDLC driver can be configured to apply a voltage to the ITO layers in order to create a bi-polar electric field at a typical excitation frequency of 5 kHz. The PDLC driver can be configured as current sources gated by switches to drive the capacitive load of the PDLC. A first FET 452a coupled to a voltage source and configured as a current source can be switched using a first FET switch 454a to apply the voltage to the first ITO layer 420a of the first PDLC and the second ITO layer 422b of the second PDLC. A coupling resistor 456 couples the gate of the first FET switch 454a to a controller output (not shown). The full bridge driver bias supply voltage can be a high DC voltage, such as 150 VDC, thereby enabling a ±150V excitation to the PDLC. A second FET 452b coupled to the voltage source and configured as a current source can be switched using a second FET switch 454b to apply the voltage to the second ITO layer 420b of the first PDLC and the first ITO layer 422a of the second PDLC. A coupling resistor 456b couples the gate of the second switching FET 454b to a controller output (not shown).

A heating power source is coupled to the ITO layers 420a-b and 422a-b to heat the associated PDLC layers. The heating power source includes a switch mode modulator 430 such as a flyback modulator coupled to the gate of a switching transistor 432. Typically, the switching transistor 432 is a switching FET. The primary side 442 of a transformer 440 couples the switching transistor 432 to a power source. The power source used for the pulsed power can be a battery (not shown) such as an AA battery, or more likely, a back-up energy storage capacitor. The storage capacitor can be sized for the energy needs of the PDLC at the lowest ambient temperature. A typical capacitor value would be 150 uF at 300 VDC the energy in the capacitor is replenished after each heater application cycle. This way, the pulsed peak loads on the battery are minimized and an optimally sized small battery can be used. The storage capacitor remains charged at all times until needed, but is not necessary until the ambient temperature drops below +25° C. Above this temperature, heat is unnecessary and the high voltage bias to the PDLC from the storage capacitor is disabled. The details of the back-up storage capacitor and charging system are not indicated in FIG. 3.

A first secondary winding 444a of the transformer 440 has a first capacitor 446a coupled across its terminals. Transformer 440 couples the power to the PDLC to heat associated ITO layers. The first capacitor 446a filters the pulsating power from the half rectified secondary generated from winding 444a. A first reverse polarity diode 448a couples a positive side of the first capacitor 446a to electrodes of the first ITO layer 420a of the first PDLC and the second ITO layer 422b of the second PDLC. The opposite or negative side of the capacitor 446a is coupled to the electrodes positioned on the opposite ends of the first ITO layer 420a of the first PDLC and the second ITO layer 422b of the second PDLC.

A second secondary winding 444b of the transformer 440 has a second capacitor 446b coupled across its terminals. Similarly, the transformer 440 couples the power to the PDLC to heat associated ITO layers. The second capacitor 446b filters the pulsating power from the half rectified secondary generated from winding 444b. A second reverse polarity diode 448b couples a positive side of the second capacitor 446b to electrodes of the second ITO layer 420b of the first PDLC and the first ITO layer 422a of the second PDLC. The opposite or negative side of the second capacitor 446b is coupled to the electrodes positioned on the opposite ends of the second ITO layer 420b of the first PDLC and the first ITO layer 422a of the second PDLC.

The temperature of the PDLC layers can be indirectly determined by determining the resistance of one or more of the ITO layers and relating the measured temperature of the ITO layers to the temperature of the PDLC layers. The temperature monitor can include a voltage reference providing a constant current source to a bridge circuit having one or more ITO layers positioned as one element in a temperature sensitive leg of the bridge. A difference amplifier can amplify the voltage difference between a reference leg of the bridge and the temperature sensitive leg of the bridge.

The voltage reference can include a reference source 462 that is configured with an operational amplifier (op amp) 460 to provide a stable high impedance constant current source reference. A resistor 464 couples an output of the reference source 462 to a non-inverting input of the op amp 460. The current level can be set based on the voltage reference divided by the resistance 464. This method eliminates the forward voltage drop loss of the reverse polarity diode 466. The reverse polarity diode 466 couples the non-inverting input of the op amp 460 to the bridge circuit. Reverse polarity diode 466 is reverse biased when the PDLC is excited by the full bridge driver operating at ±150 VAC and isolates both the driver, heater, and temperature excitation circuits from each other. Likewise when the temperature measurement is performed, the heater diodes 448a and 448b are reversed biased and therefore do not influence the measurement.

The reference leg of the bridge includes a first reference resistor 472 coupled to the cathode of the reverse polarity diode 466. The opposite end of the first reference resistor 472 is coupled to a second reference resistor 474. The second reference resistor 474 is coupled to a FET switch that can selectively switch the series combination of the first and second reference resistors 472 and 474 to ground. The FET switch includes a FET 476 and an input resistor 478 that couples the gate of the FET 476 to a temperature enable output of a controller (not shown).

The temperature sensitive leg of the bridge can include a fixed resistor 470 that couples the cathode of the reverse polarity diode 466 to at least one of the ITO layers. In the embodiment shown in FIG. 3, the fixed resistor 470 is coupled to the second ITO layer 420b of the first PDLC and the first ITO layer 422a of the second PDLC.

A first coupling resistor 492 connects the reference leg of the bridge to a first input of a difference amplifier 480. A first protection diode 496 is used to protect the difference amplifier 480 from potential over voltage damage.

A second coupling resistor 490 couples the temperature sensitive leg of the bridge to the second input of the difference amplifier 480. A second protection diode 494 is used to protect the difference amplifier 480 from potential over voltage damage. The gain of the difference amplifier 480 is set by resistor 482. A typical gain value can be 200, although the exact value of gain may vary depending on the exact bridge configuration

The temperature monitor can be used to determine the temperature of the PDLC layers by determining the value from the difference amplifier and relating the value to a temperature. To monitor the temperature, the FET switch 476 is closed to provide a current path through the reference leg of the bridge. A FET switch, here 454b, is closed to provide a current path through the temperature sensitive leg of the bridge that includes the one or more ITO layers. The bridge output is then amplified by the difference amplifier 480. In one embodiment, the output of the difference amplifier 480 can be compared against a predetermined table (not shown) that correlates the amplified value to a temperature.

Thus, the wide temperature range PDLC system 200 shown in FIG. 3 may operate in the following manner. The FET switches in the temperature monitor bridge circuit, 476 and 454b, can close based on drive signals provided by a controller (not shown). The difference amplifier 480 can then output a value that can be related to a temperature of the PDLC layers. The FET switches 476 and 454b can then be returned to open circuit states.

If the temperature is less than or equal to a predetermined heating threshold, one or more heating pulses can be applied to the ITO layers, 420a-b and 422a-b. The controller (not shown) can selectively enable the switch mode modulator 430 to couple a pulse of energy to the secondary windings 444a and 444b of the transformer 440.

The energy from the secondary windings 444a and 444b is supplied to the resistive ITO layers 420a-b and 422a-b and heats the PDLC layers. The temperature of the PDLC can be repetitively monitored and heating pulses applied to the ITO layers 420a-b and 422a-b until the system determines the temperature of the PDLC is greater than the predetermined threshold.

The system can, concurrent with the heating, apply the voltage to the PDLC to create the oscillating bi-polar electric field. The controller (not shown) can control the PDLC driver to provide a voltage to one or more of the ITO layers, for example 420a and 422b, relative to the opposite ITO layer, for example 420b and 422a.

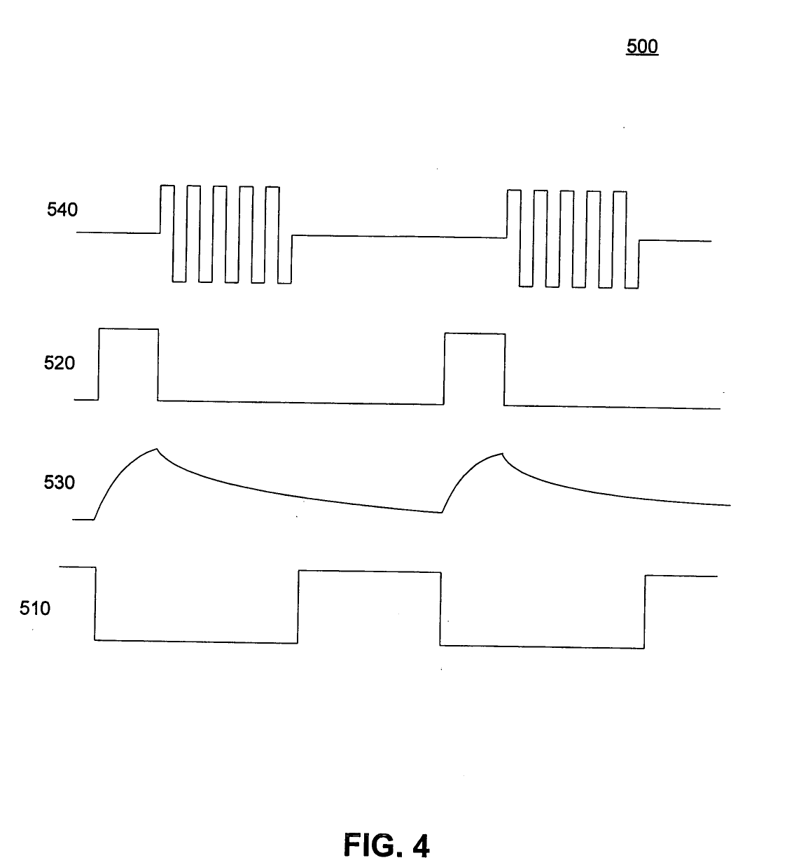

FIG. 4 is a timing diagram 500 of the sequence of events for the embodiment of FIG. 3. The timing diagram 500 begins at a period of time near the end of a temperature monitoring period in which it is determined that a heating pulse is desired. The plot for the temperature monitor signal 510 is shown as completing a cycle and transitioning to an inactive state. The heat enable signal 520 is shown transitioning to an active state. During the active state of the heat enable signal 520, the system can apply one or more heating pulses to the ITO layers. The temperature of the PDLC 530 rises during the time that the heater is enabled.

At the end of the heating cycle, the heat enable signal 520 transitions back to an inactive state. The PDLC shutter control signal 540 can selectively energize the PDLC to control the PDLC to a transparent state. The shutter control signal 540 is shown as an AC square wave to denote the voltages of opposite polarity applied to the PDLC in order to minimize a buildup of residual charge on the PDLC that sometimes results when a DC voltage is used. The temperature of the PDLC 530 drops during the time the PDLC is enabled because the heater is no longer active.

After the PDLC shutter signal 540 returns to an inactive state, the temperature of the PDLC 530 continues to drop to a steady state value that is typically determined by the environment in which the PDLC is housed. The temperature monitor signal 510 can transition to an active state and continue to monitor the temperature of the PDLC until the time of the next heating cycle.

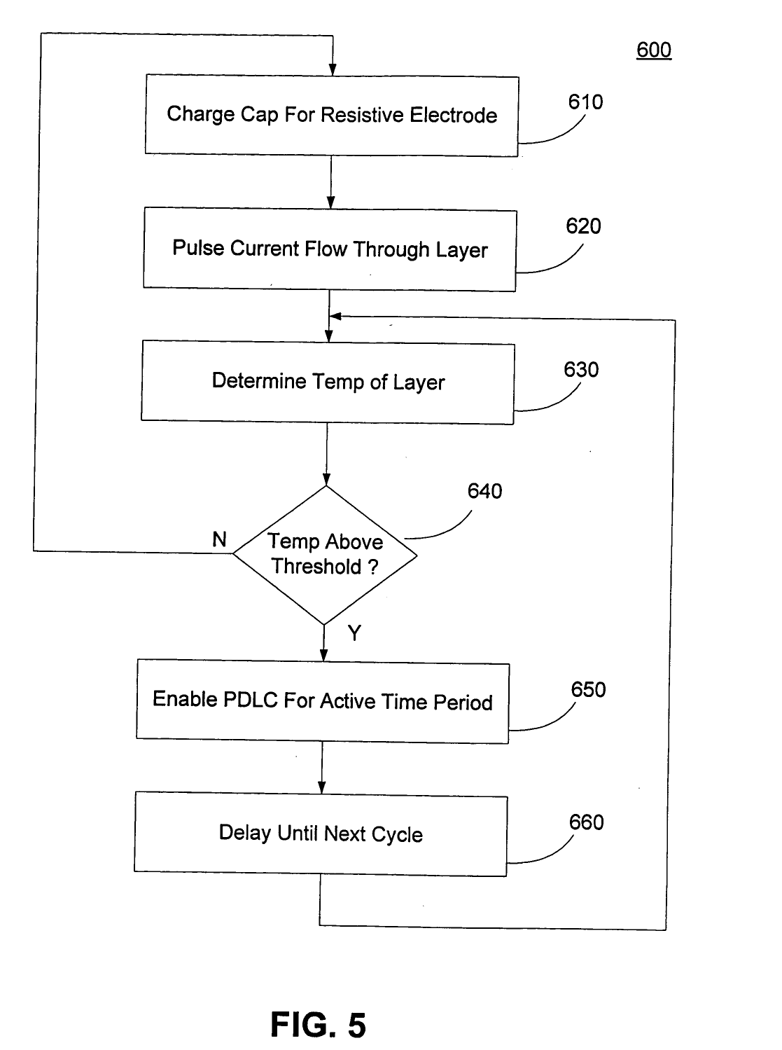

FIG. 5 is a flowchart of an embodiment of a method 600 of operating a wide temperature range PDLC system. The method can be used, for example, by the wide temperature range PDLC systems 200 shown in FIGS. 2A, 2B, and 3. The method 600 can be, for example, implemented within the controller 270 of FIGS. 2A and 2B. In one embodiment, the method 600 can be implemented in software as one or more processor readable instructions stored in memory 274 and operated on by a processor 272 of a controller 270, such as the controller 270 of FIG. 2B.

The method 600 can begin at block 610 where the controller controls the system to charge the capacitors used to heat the PDLC. The controller then proceeds to block 620 where the controller can pulse the current flowing through the ITO layers. In an embodiment such as the embodiment shown in FIG. 3, the actions performed in blocks 610 and 620 may be combined into a single action. For example, the controller can control the switch mode modulator 430 to couple a pulse of energy to the secondary of the transformer 440 and thus, to the ITO layers.

The controller then proceeds to block 630 and determines the temperature of the PDLC. The controller can, for example determine the temperature directly using a temperature sensor or can determine the temperature indirectly by determining a value that can be related to PDLC temperature. For example, in the embodiment of FIG. 3, the temperature monitor determines the temperature of the PDLC by using a bridge that includes one or more ITO layers in one of the legs of the bridge. The temperature monitor uses the bridge to determine a resistance of the ITO layers. The resistance of the ITO layers is then related to the temperature.

After determining the temperature of the PDLC, the controller can proceed to decision block 640 to determine if the temperature exceeds a predetermined temperature threshold. As noted earlier, the operational characteristics of the PDLC may slow at lower temperatures. To preserve battery power, the system can be configured to provide heat when the temperature of the PDLC is within the range of temperatures where slowing of the operational characteristics is expected. For example, the predetermined temperature threshold may be 15, 16, 18, 20, 22 or 25° C.

If the temperature is not above the predetermined threshold, the controller can return to block 610 to provide an additional heating pulse. However, if the temperature of the PDLC is greater than the threshold, the controller can proceed to block 650 and enable the PDLC for a period that may be a predetermined active time period.

The controller can then proceed to block 660 and delay further operation until the next scheduled operation cycle of the PDLC. Once the next cycle arrives, the controller can proceed back to block 630 to determine the temperature of the PDLC. The temperature of the PDLC may be different than a previously determined value due to changes in the operating environment or due to residual heat from prior heating cycles.

Although a particular sequence is shown in the method 600 of FIG. 5, the method 600 is not limited to the steps or sequence shown in FIG. 5. For example, block 630 may represent the initial step of the method 600. Additional steps or processes may be added to the method 600 and the additional steps or processes may be added between existing process steps. Moreover, some steps or process flows may be omitted from the method. For example, the method may be limited to a single heating cycle per PDLC shutter operation. Thus, repetitive heating cycles may be omitted.

The above description of the disclosed embodiments is provided to enable any person skilled in the art to make or use the disclosure. Various modifications to these embodiments will be readily apparent to those skilled in the art, and the generic principles defined herein may be applied to other embodiments without departing from the scope of the disclosure. Thus, the disclosure is not intended to be limited to the embodiments shown herein but is to be accorded the widest scope consistent with the principles and novel features disclosed herein.

1. A Polymer Dispersed Liquid Crystal (PDLC) system comprising:
a PDLC layer;
a first resistive layer disposed on a first side of the PDLC layer, and configured to have electrodes positioned on opposite ends of the first resistive layer;
a second resistive layer disposed on a second side of the PDLC layer opposite the first side, the second resistive layer having electrodes positioned on opposite ends of the second resistive layer; and
a power source selectively coupled to the first and second resistive layers.

2. The system of claim 1, further comprising a controller configured to determine a temperature of the PDLC layer and control the coupling of the power source to the first and second resistive layers based in part on the temperature.

3. The system of claim 2, wherein the controller determines the temperature using a temperature monitor.

4. The system of claim 3, wherein the temperature monitor comprises:
a bridge circuit having a reference leg and a temperature sensitive leg, the temperature sensitive leg including at least one of the resistive layers as a resistive element; and
a difference amplifier configured to amplify a voltage difference between a voltage on the reference leg of the bridge and a voltage on the temperature sensitive leg of the bridge.

5. The system of claim 1, further comprising a driver configured to selectively apply an electric field to the PDLC layer by applying a voltage to the first and second resistive layers.

6. The system of claim 1, further comprising:
a first thermal insulating substrate disposed on a side of the first resistive layer opposite a side nearest the PDLC layer; and
a second substrate disposed on a side of the second resistive layer opposite the side nearest the PDLC layer.

7. The system of claim 6, wherein the first and second thermal insulating substrates comprise transparent substrates.

8. The system of claim 7, wherein the transparent substrates comprise substrates substantially transparent to at least a portion of a visible light spectrum.

9. The system of claim 6, wherein the first and second substrates comprise transparent quartz substrates.

10. The system of claim 1, wherein the PDLC layer comprises liquid crystal droplets of approximately 1.55 μm diameter.

11. The system of claim 1, wherein the PDLC layer is approximately 16 to 100 μm thick.

12. The system of claim 1, wherein the first and second resistive layers comprise transparent resistive layers.

13. The system of claim 1, wherein the first resistive layer comprises an Indium-Tin-Oxide (ITO) layer.

14. The system of claim 1, wherein the first and second resistive layers comprise substantially transparent Indium-Tin-Oxide (ITO) layers having a resistance of approximately 100 ohms per square.

15. The system of claim 1, wherein the power source comprises at least one capacitor configured to provide energy to at least one of the resistive layers.

16. The system of claim 1, wherein the power source comprises:
a DC power source;
a boost DC-DC converter configured to step up a voltage of the DC power source; and
a capacitor configured to be charged to a stepped up voltage output from the boost converter.

17. The system of claim 1, wherein the power source comprises:
a battery;
a transformer having a primary winding and a secondary winding, a first end of the primary winding coupled to the battery; and
a switch mode modulator coupled to the primary winding and configured to selectively couple a pulse of energy from the battery to the secondary winding.

18. A Polymer Dispersed Liquid Crystal (PDLC) system comprising:
a PDLC layer having liquid crystal droplets of a diameter that is greater than or approximately equal to one wavelength of a desired wavelength;
a first Indium-Tin-Oxide (ITO) layer disposed on a first side of the PDLC layer, the first ITO layer having first and second electrodes positioned on opposite ends of the first ITO layer;
a second ITO layer disposed on a second side of the PDLC layer, the second ITO layer having first and second electrodes positioned on opposite ends of the second ITO layer;
a PDLC driver configured to apply an electric field to the PDLC layer by applying a voltage to the first ITO layer relative to the second ITO layer;
a power source coupled to the electrodes on each of the ITO layers and configured to selectively provide a current to each of the ITO layers that flows from the first electrode to the second electrode; and
a controller configured to determine a temperature of at least one ITO layer and further configured to control the power source to selectively provide the current based in part on the temperature.

19. A method of operating a Polymer Dispersed Liquid Crystal (PDLC) over a wide temperature range, the method comprising:
determining a temperature of the PDLC;
determining if the temperature is greater than a predetermined temperature threshold; and
applying a heating current to at least one a resistive layer of the PDLC if it is determined that the temperature is not greater than the predetermined temperature.

20. The method of claim 19, wherein applying the heating current comprises:
charging a capacitor; and
discharging the capacitor at least in part using at least one resistive layer of the PDLC.

21. The method of claim 20, wherein discharging the capacitor comprises discharging the capacitor across electrodes positioned on opposite sides of a first Indium-Tin-Oxide (ITO) layer of the PDLC.

22. The method of claim 19, further comprising enabling the PDLC by applying an electric field to the PDLC layer.

23. The method of claim 22, further comprising delaying a predetermined PDLC cycle time.

24. The method of claim 19, wherein determining the temperature of the PDLC comprises:
determining a voltage in a reference leg of a bridge circuit, the reference leg comprising a plurality of reference resistors;
determining a temperature sensitive voltage in a temperature sensitive leg of the bridge circuit, the temperature sensitive leg comprising at least one ITO layer of the PDLC as a resistive element;
amplifying the difference between the voltage in the reference leg and the temperature sensitive voltage; and
comparing an amplified voltage to a predetermined threshold voltage.
